(19) United States
(12) Patent Application Publication
(10) Pub. No.: US 2023/0256401 A1
(43) Pub. Date: Aug. 17, 2023

(54) MODULAR BLENDER AND METHOD OF USING SAME

(71) Applicant: Merck Sharp & Dohme LLC, Rahway, NJ (US)

(72) Inventors: William Blincoe, Fords, NJ (US); James C. DiNunzio, Flemington, NJ (US); M. Sebastian Escotet Espinoza, New York, NY (US); Sung Woo Kim, Lyndhurst, NJ (US); Graciela Terife, Hoboken, NJ (US)

(73) Assignee: Merck Sharp & Dohme LLC, Rahway, NJ (US)

(21) Appl. No.: 17/920,876

(22) PCT Filed: Apr. 26, 2021
(86) PCT No.: PCT/US2021/029043

§ 371 Date: Oct. 24, 2022

Related U.S. Application Data
(60) Provisional application No. 62/704,270, filed on May 1, 2020.

(51) Int. Cl. B01F 27/07; B01F 27/1144; B01F 27/70

(52) U.S. Cl. CPC B01F 27/071; B01F 27/1144; B01F 27/70

(57) ABSTRACT

A blender includes a proximal section having a proximal upper housing and a proximal lower housing, a distal section having a distal upper housing and a distal lower housing, at least one intermediate section disposed between the proximal section and the distal section and coupleable thereto, each of the at least one intermediate section including an intermediate upper housing and an intermediate lower housing, a shaft extending through the proximal section, the distal section and the at least one intermediate section, and at least one blade disposed on the shaft.

### CROSS-REFERENCE TO RELATED APPLICATIONS

This application claims priority to U.S. Provisional Application Ser. No. 62/704,270 filed May 1, 2020, the disclosure of which is hereby incorporated by reference in its entirety as if fully set forth herein.

### FIELD OF THE DISCLOSURE

The present disclosure relates to apparatuses and methods for blending materials. More particularly, the present disclosure relates to modular blenders capable of processing batches of material.

### BACKGROUND OF THE DISCLOSURE

In manufacturing, blenders are used to mix materials, such as powders. Conventional blenders are often large, expensive machinery designed to produce large batches. Due to their size and cost, they are generally incapable of producing a small batch of blended material, and are difficult to modify. Additionally, conventional blenders may be difficult to clean and may not provide the ability to sample at various locations along the blender to test mixing of a blend without disturbing the blending process.

Typically, a continuous powder blender may also have a constant fill amount of material, known as the mass holdup, that is given by the transit of material from the inlet to the outlet. The mass holdup is an amount of material that is retained in the unit at all times and inaccessible when the shaft stops rotating; thus, it is often treated as “yield loss” or waste in the process. For commercially available units, ranging in volume from 0.5 L to 15 L, the mass holdup ranges between 200 to 3,000 grams of powder depending on the formulation; making yield loses significant for small batch operations and continuous blending operations an unsurmountable hurdle in some industries.

### SUMMARY OF THE DISCLOSURE

In one embodiment, a blender includes a proximal section having a proximal upper housing and a proximal lower housing, a distal section having a distal upper housing and a distal lower housing, at least one intermediate section disposed between the proximal section and the distal section and coupleable thereto, each of the at least one intermediate section including an intermediate upper housing and an intermediate lower housing, a shaft extending through the proximal section, the distal section and the at least one intermediate section, and at least one blade disposed on the shaft.

### BRIEF DESCRIPTION OF THE DISCLOSURE

Various embodiments of the presently disclosed devices and methods are disclosed herein with reference to the drawings, wherein:

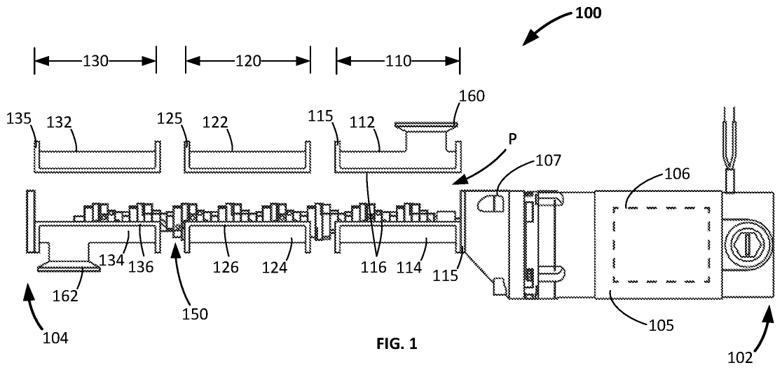

FIG. 1 is a schematic exploded side view of one embodiment of a blender according to the present disclosure;

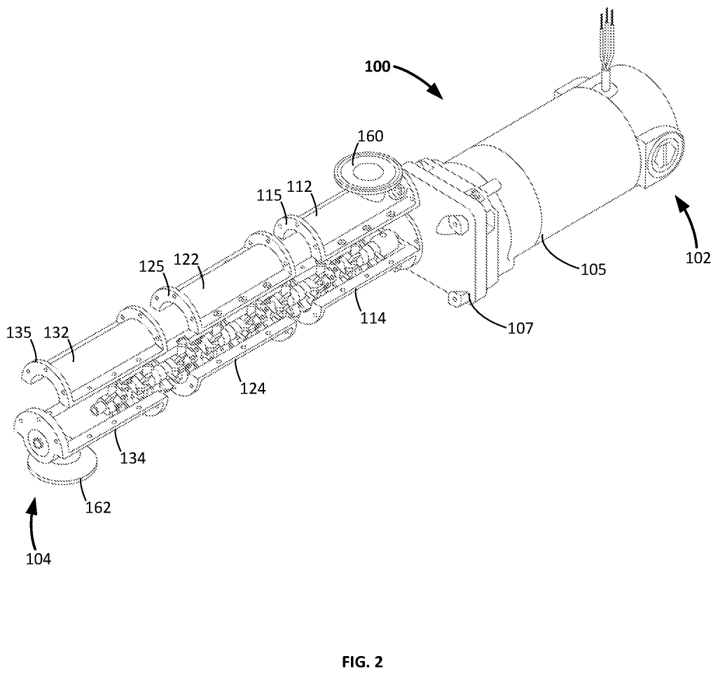

FIG. 2 is a schematic exploded perspective view of the blender of FIG. 1;

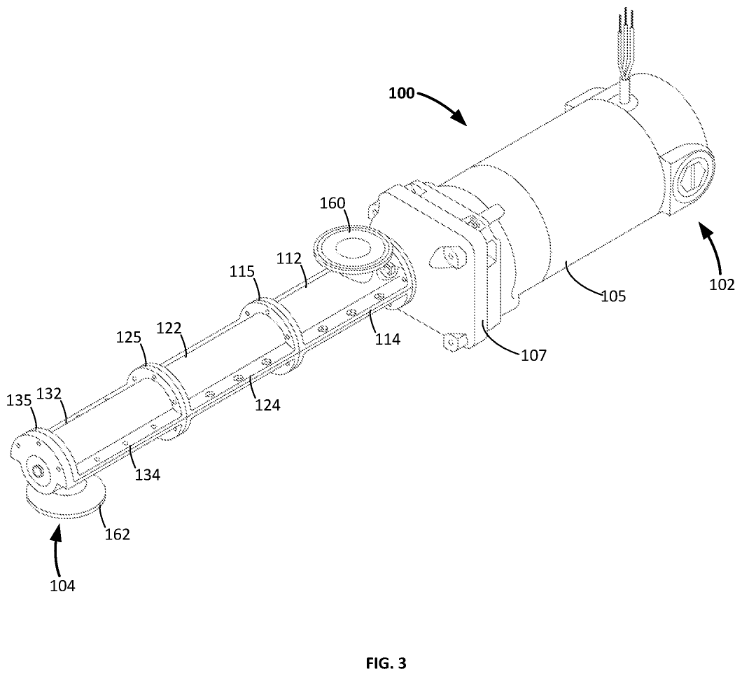

FIG. 3 is a schematic perspective view of the blender in its assembled condition;

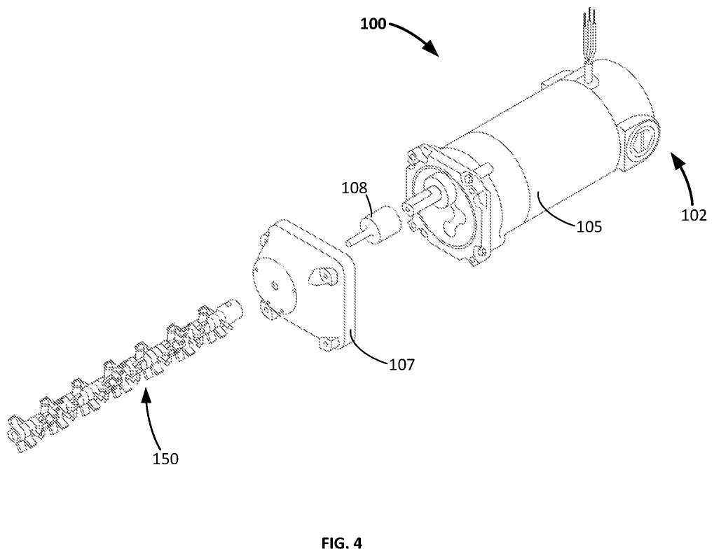

FIG. 4 is a schematic perspective view showing assembly of a shaft and blades to an enclosure;

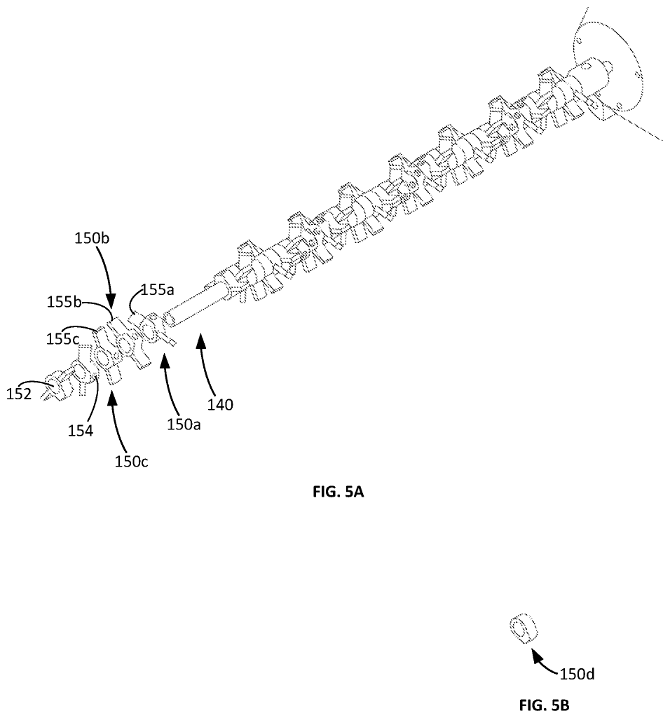

FIG. 5A is a schematic detailed perspective view of blades coupled to a shaft;

FIG. 5B is a schematic perspective view of a spacer;

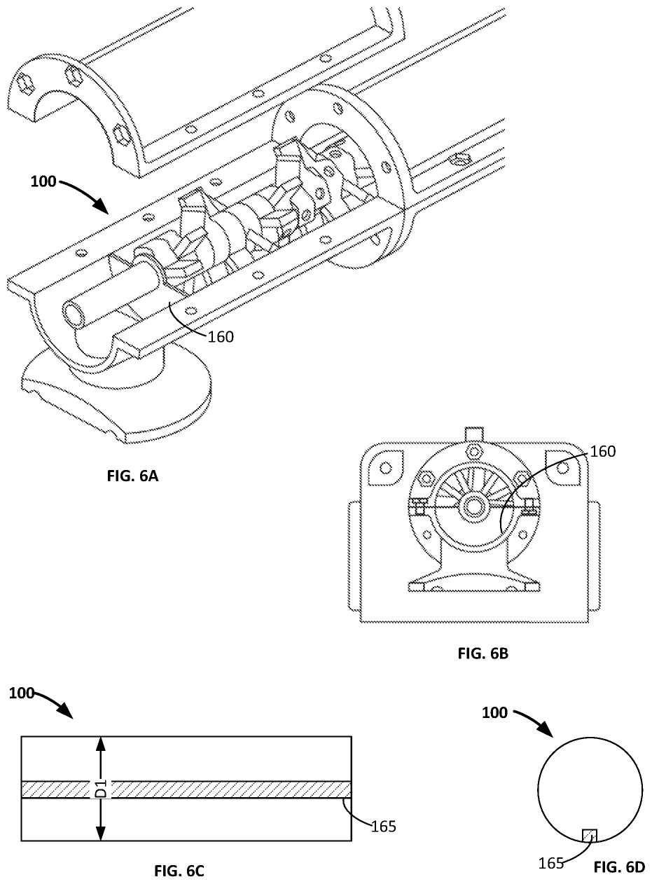

FIGS. 6A-B are schematic perspective and end views of a blender having a weir;

FIGS. 6C-D are schematic top and end views of a blender having a baffle;

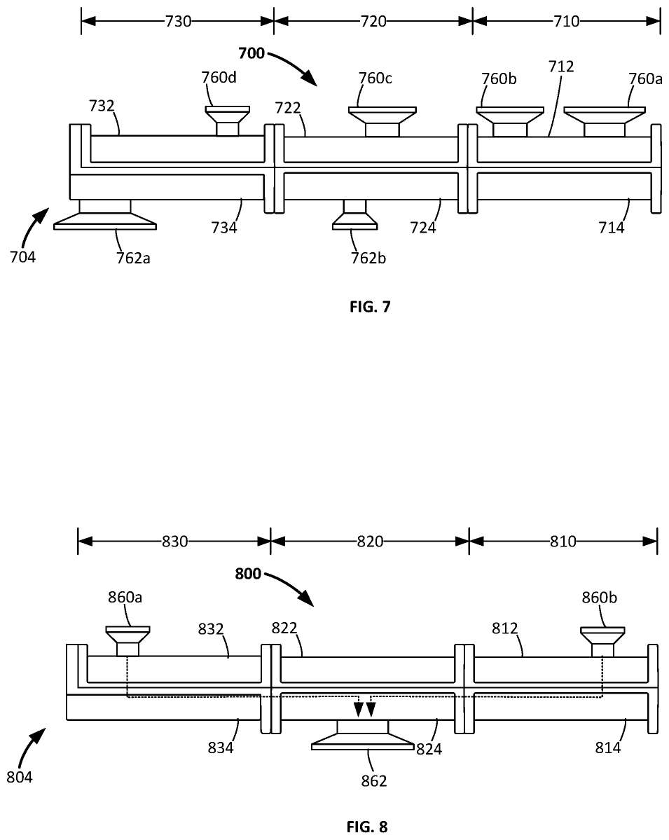

FIGS. 7-8 are schematic side views showing alternative embodiments of a blender having multiple inlets and/or outlets; and

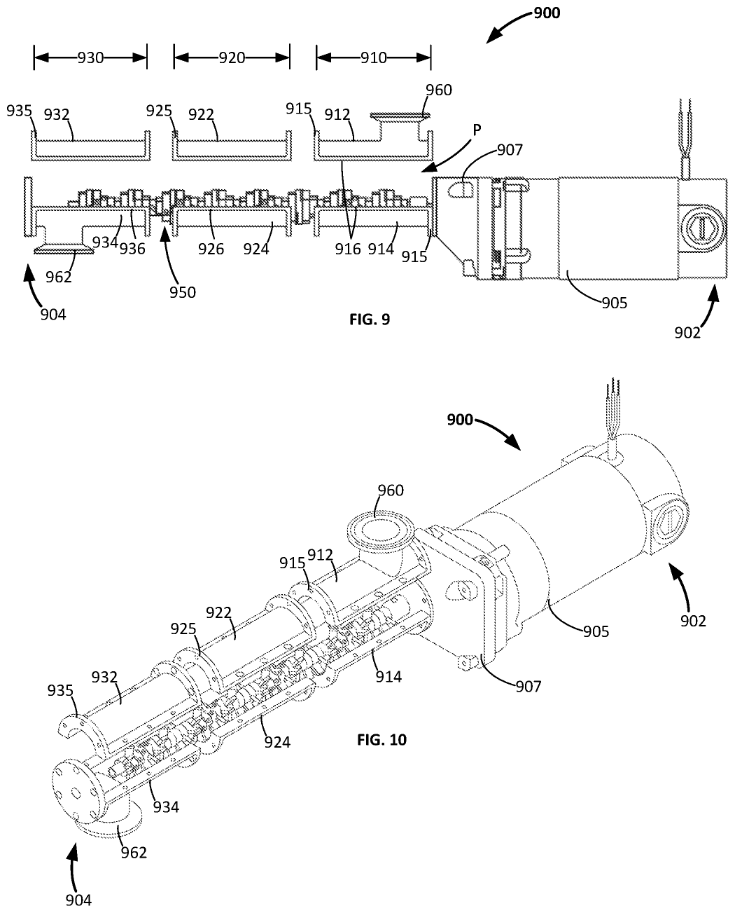

FIGS. 9-10 are schematic exploded side and perspective views showing an alternative embodiment of a blender.

Various embodiments will now be described with reference to the appended drawings. It is to be appreciated that these drawings depict only some embodiments of the disclosure and are therefore not to be considered limiting of its scope.

### DETAILED DESCRIPTION

Despite the various improvements that have been made to blenders, conventional devices and methods suffer from some shortcomings as described above.

Therefore, there is a need for further improvements to the devices and methods used for blending materials, such as powders. Among other advantages, the present disclosure may address one or more of these needs.

As used herein, the term “proximal” may refer to an end of the device closest to the inlet or to a user in handheld applications, while the term “distal” may refer to an end of the device closest to the outlet or farthest from a user in handheld applications. Additionally, the terms “blender”, “blending device” and “mixer” may be used interchangeably to refer to a device capable of mixing materials (e.g., a continuous powder mixer).

FIGS. 1-5B illustrate one embodiment of blender 100 according to the disclosure. Blender 100 generally extends between a proximal end 102 and a distal end 104, and may include an enclosure 105 having a motor 106, and other electrical and/or mechanical components to power the blender. A hub 107 is coupled to enclosure 105 via adapter 108 (best seen in FIG. 4). Adapter 108 may be configured and arranged to have the exact penetration depth into the shaft for secure coupling of the shaft (with the screw) but easy to remove from the shaft so to not disturb the held up powder bed.

The blending portion of device 100 generally includes three or more sections: proximal section 110, one or more intermediate sections 120 and distal section 130. Each section may include an upper and a complementary lower housing configured to mate or couple together to form an annular shell. The housings may be formed of a nylon, plastic, metal, or other suitable material. In some examples, the housings are translucent or formed of a clear photopolymer so that the user is capable of seeing the processing of the material within the shell. Thus, proximal section 110 may include a proximal upper housing 112 and a complementary proximal lower housing 114. Intermediate section(s) 120 may include intermediate upper housing(s) 122 and complementary intermediate lower housing(s) 124. Distal section 130 may include a distal upper housing 132 and a complementary distal lower housing 134. In at least some examples, the shell sections are formed of complementary upper and lower housings that form clamp shells, the clamp shells being able to mate together along axial ridges 116,126,136 and form a substantially cylindrical central passageway “P” from the hub 107 to the distal end of the device. The upper and lower housings may be secured together along ridges 116,126,136 via pins, screws, clips or any other suitable means. Each of the upper and lower housings may also include a brim 115,125,135 that abuts, or couples to, an adjoining brim (e.g., brim 115 on one end of the proximal section 110 abuts brim 125 of section 120) or to a hub (e.g., brim 115 on the second end of section 110 abuts hub 107) to provide a fluid-tight seal between the two components, forcing material to flow through the central passageway “P” without leaking out between the sections when the housings are assembled together (FIG. 3).

It will be understood that multiple (e.g., one two, three, four or five) intermediate sections 120 may be used in series. Additionally, the length of intermediate section 120 may be selected as desired. For example, intermediate section 120 may be longer than proximal section 110 and/or distal section 130 or both combined, or intermediate section 120 may be shorter than either proximal section 110 and/or distal section 130 or both combined.

A central shaft 140, best seen in FIG. 5A, may pass through the three sections and longitudinally extend through the central passageway “P” formed by the housings, the shaft being operatively coupled to the motor and configured to spin about its central axis. In at least some examples, shaft 140 is formed of multiple segments that are coupled together, and the number of segments may be equal to the number of sections of the device (e.g., three segments for a device having a proximal section, a distal section and one intermediate section). For example, shaft 140 may include a proximal segment, at least one intermediate segment and a distal segment, each segment being coterminous with respective sections 110,120,130.

In the example shown, a plurality of blades 150 are coupled to shaft 140 and configured to spin with the shaft. As shown in FIG. 4, each blade 150 may have a lumen 152 so that it slides over shaft 140. Each blade 150 may also have a threaded hole 154 to enable tightening of the blade onto shaft 140 via a screw, pin or other similar mechanism to affix the blade at one position on the shaft and prevent movement of the blade across the shaft. Alternatively, instead of being removably coupleable to the shaft, the blades may be unitarily formed with the shaft. Blades 150 may come in a variety of configurations. For example, blades 150 may include at least one blade 150a having a forward-facing fin or fins 155a configured to move material (e.g., a powder) forward from the proximal end of the device toward the distal end of the device. Blades 150 may also include at least one blade 150b having radial-facing fins 155b configured to drive material (e.g., a powder) radially outward toward the inner walls of housings 112,114,122,124,132,134. Blades 150 may also include at least one blade 150c having rear-facing fins 155c configured to move material (e.g., a powder) backward from the distal end of the device back toward the proximal end of the device. Blades 150d may also be used, which have no fins at all and function merely as spacers to change the distance between two blades (FIG. 5B). Any number of spacers may be used, and the thickness of spacers may be varied to provide the desired spacing between blades.

It will be understood that fins may be arranged at different angles so that, for example, a forward-facing fin may drive material forward at different rates based on the angle. Additionally, by mixing and matching the number and/or types of blades 150 coupled to a shaft, a specific mixing profile including mixing total time, time of mixing within a particular section, predetermined target results of mixing within a section, ingredients to be mixed and other criteria may be possible. For example, a greater number of forward-facing fins 150c will drive the material quicker toward the distal end, while a greater number of rear-facing fins may reduce the rate of material processed through the blender.

In addition to the blades and/or spacers, a blender may include one or more elements, which serve as removable or repositionable flood gates to slow or stop material from moving across sections. Optionally, weirs 160 may be placed between any proximal and intermediate section, between any two intermediate sections, and/or between any intermediate and distal section of the blender (FIGS. 6A-B). In at least some examples, the weirs 160 are half-moon-shaped or semi-circular elements having a height, the weirs being capable of impeding the movement of a material, while allowing the material to flow above it. The device may also include one or more continuous or discontinuous baffles 165, formed as axially-extending ridges as shown in the top and end view of FIGS. 6C-D. Baffles 165 may have a predetermined height that is a proportion of the total height of the device's inner diameter (e.g., 1/20, 1/15, 1/10, ⅛, ⅙, ⅕, ¼, ⅓, ½ or more of the total height of the inner diameter D1 of the device). Continuous or discontinuous baffles 165 may extend through one or multiple sections, and different baffles may have different heights. Additionally, a single baffle may have a variable height that changes height from one end of the device to the other.

Turning back to FIGS. 1-2, a single inlet 160 and a single outlet 162 are shown. In the examples shown, inlet 160 is defined within, coupled to, or unitarily formed with, proximal upper housing 112, and outlet 162 is defined within, coupled to, or unitarily formed with, distal lower housing 134. In this configuration, one or more materials (e.g., a powder, fluid, etc.), enter through inlet 160, travel within cavities of the sections being pushed forward by blades disposed on the shaft toward the distal end, and exit through outlet 162 when properly mixed. The two outlets are of the same size.

FIG. 7 illustrates an alternative embodiment in which a blender includes three sections and multiple inlets and outlets. Specifically, blender 700 includes proximal section 710, intermediate section 720 and distal section 730 having upper and lower housings 712,714, 722,724, and 732,734 respectively. In this example, blender 700 includes two inlets 760a,760b in proximal section 710, an inlet 760c in intermediate section 720, and an inlet 760d in distal section 730. The inlets may receive a same material or different materials selected from one or more powders and/or liquids. The inlets may all be the same size, or different sizes. As shown, two outlets, 762a,762b are formed, one in the distal section 730, and a second in the intermediate section 720. The two outlets 762a,762b may be of the same size or different sizes. In at least some examples, outlet 762b is relatively small so as to allow sampling of the blending of the material. Any one of the outlets 762a,762b may be in the form of a sampling port having a valve to allow it to transition between an open position and a closed position. In this way, an outlet may be opened to allow exit of the material (e.g., for sampling) or closed when not needed. In another example, shown in FIG. 8, a blender 800 may include a first inlet 860a at the distal end, and a second inlet 860b adjacent the proximal end, and an outlet 862 in the intermediate section, so that material is sent from the extremities of the device toward the center and through the common outlet as shown by the arrows. In this example, outlet 862 is larger than the inlets 860a,860b.

FIGS. 9-10 illustrate another embodiment of a blender 900 that generally extends between a proximal end 902 and a distal end 904. Here, the illustrated blender 900 includes pluralities of like-numbered elements that are substantially similar to those described above with reference to FIG. 1, except that the elements are preceded by a “9” instead of a “1”. Thus, blender 900 includes a motor 906 that is similar to motor 106 of the first embodiment. The blending portion of device 900 may also include three sections 910,920,930 and corresponding upper housings 912,922,932, lower housings 914,924,934 and axial ridges 916,926,936. Brims 915,925,935 abut, or couple to, adjoining brims and blades 950 are provided between the housings as previously described. In this example, inlet 960 and outlet 962 have a same inner diameter. In fact, in at least some examples, upper housing 912 including inlet 960 and lower housing 934 including outlet 962 are interchangeable to increase modularity and manufacturability.

In this manner, a miniaturized continuous powder blending device may be formed having a modular axial arrangement (i.e., a device having separable sections along its longitudinal axis), and a clamp shell radial design. The blending device may be inexpensively manufactured with disposable materials (e.g., nylon, polypropylene, ABS, PLA or combinations thereof, opening up the potential for single-use applications.

The blending device may be used to mix powder received through the inlet(s), and displacing that powder within passageway “P” along the longitudinal axis from the inlet(s) to the outlet(s) using the rotating shaft and the blades having fins. Specifically, segregated or unmixed powders may continuously enter through the inlet and are pushed forwards and/or radially by the rotating motion of the blades' fins coupled to the shaft until they exit via one of the outlets. The operation may be continuous as the rate of unmixed material entering the inlet and the rate of mixed material exiting the outlet are equal.

The blending device may provide a sufficiently-mixed powder blend through the outlet, and the mixed powder may be sent to other manufacturing steps. The extent of mixing may be based on the speed of the blades, the flow rate of the powders coming through the inlet(s), the number of fins on a blade and their angles, the diameter of the passageway, inclination of the blender, and/or the length of the passageway. Additionally, the length of the passageway may be varied by adding or removing intermediate sections 120, and the intermediate sections 120 may be formed of a predetermined length needed to achieve a particular mixing profile. The shaft and blades can also be easily varied as discussed.

Blender 100 also reduces the problems associated with mass holdups by making the holdup easily accessible for later use. Specifically, after the blender 100 has stopped, the user may remove the fastening mechanism connecting the upper and lower housings of the blender and take the material for further use. Additionally, the miniaturized nature of the unit (volume <250 mL) aims at reducing the free volume of the unit and thus the amount of material held up in the system. For example, the mass holdup may be between 20 and 60 grams, a significant reduction in holdup when compared to commercial equipment, without compromising blending capabilities. In at least some examples, each section has a constant inner diameter of between 1 inch to 6 inches. In some examples, each section may be between 2 inches to 12 inches in length. In at least some examples, the inner diameter to length ratio is 1:12, 1:10, 1:8, 1:6 or 1:2.

Thus, a small amount of material may be used to evaluate continuous manufacturing at earlier stages of development. The small or hand-held blender size may also enable operation in confined spaces (i.e., can fit inside of a ventilated balance enclosure) or provide the opportunity of integrating the unit on other continuous equipment (e.g., roller compactors, twin screw extruders, twin screw granulators) making continuous lines easier to assemble for a variety of process trains.

The blenders described herein may also be manufactured to different scales depending on the intended use. For examples, blenders may be made at an analytical, lab or pilot scale. The size ranges for each blender section may be between 1 inch and 60 inches in length. In another example, the blender length is 60 inches. In another example, the blender length is comprised of five 12-inch sections. In at least some examples, the length:diameter ratio may be maintained between 12:1 and 5:1. Additionally, the range of material batches that can be manufactured with these units can range from mg of material to blend to multiple (>20 kg) kg of materials. Moreover, blenders may be configured to not only scale up (i.e., to increase size), but also scale out (i.e., increase the time the unit is running). It will also be understood that the blenders of the present disclosure may be incorporated also in small scale batch blending operations if used without outlets. Specifically, a unit may be formed with a sealed tube at one end (i.e., no outlets) and the material may be mixed for an extended period of time. After the mixing time is completed, the shell may be opened and the material extracted.

Using the disclosed devices and methods, continuous powder blending for potent or small volume products is possible. By making the equipment portable, easily disposable, and inexpensive to manufacture, many of the constraints associated with conventional devices are removed. For example, with a smaller equipment design, the blender may be easily exchanged and/or discarded for incineration, allowing for a reduction in lead time, cleaning procedures, and equipment set up. Certain components of the device may also be easily and inexpensively 3D printed or injection molded to give manufacturing sites the flexibility to work on smaller batch sizes of material and reduce the turnaround time. Moreover, the small and 3D printed, modular nature of the equipment also allows for slight modifications to the equipment quickly based on processing needs (e.g., changing number or types of blades, changing fin angles, outlet/inlet sizes, number of outlets/inlets, weir positioning, and a number of other factors).

In at least some examples, certain parts of the blender assembly that are load-bearing or dynamic are formed of a durable material, such as Nylon Polyamide 12. The upper and lower housings of the various sections may be manufactured using a clear material so that the user can see into the assembly. When 3-D printed, a material such as SOMOS® Ultraclear 10122 from DSM may be used. When injection molded, a clear, medical applications plastic such as Polypropylene (PP) or Polyphenylsulfone (PPSU) may be used. In at least some examples, Teflon may also be used. In at least some examples, certain metals (e.g., stainless steel) may also be used to form portions of the blender. In some examples, the blender may include materials that are capable of being incinerated.

It is to be understood that the embodiments described herein are merely illustrative of the principles and applications of the present disclosure. Moreover, certain components are optional, and the disclosure contemplates various configurations and combinations of the elements disclosed herein. It is therefore to be understood that numerous modifications may be made to the illustrative embodiments and that other arrangements may be devised without departing from the spirit and scope of the present disclosure as defined by the appended claims.

It will be appreciated that the various dependent claims and the features set forth therein can be combined in different ways than presented in the initial claims. It will also be appreciated that the features described in connection with individual embodiments may be shared with others of the described embodiments.

1. A blender comprising:
a proximal section having a proximal upper housing and a proximal lower housing;
a distal section having a distal upper housing and a distal lower housing;
at least one intermediate section disposed between the proximal section and the distal section and coupleable thereto, each of the at least one intermediate section including an intermediate upper housing and an intermediate lower housing;
a shaft extending through the proximal section, the distal section and the at least one intermediate section; and
at least one blade disposed on the shaft.

2. The blender of claim 1, further comprising an inlet disposed in the proximal section on one of the proximal upper housing or the proximal lower housing.

3. The blender of claim 1, further comprising an outlet disposed in the proximal section on one of the distal upper housing or the distal lower housing.

4. The blender of claim 1, further comprising multiple inlets.

5. The blender of claim 4, wherein the multiple inlets have different sizes.

6. The blender of claim 1, further comprising multiple outlets.

7. The blender of claim 6, wherein the multiple outlets have different sizes.

8. The blender of claim 6, wherein at least one of the multiple outlets includes a closeable valve that can be placed in an open position or a closed position.

9. The blender of claim 1, wherein the at least one intermediate section includes multiple intermediate sections disposed between the proximal section and the distal section.

10. The blender of claim 1, wherein the at least one intermediate section is shorter than the proximal section.

11. The blender of claim 1, wherein the at least one intermediate section is longer than the proximal section.

12. The blender of claim 1, wherein the shaft includes multiple coupleable segments including a proximal segment coterminous with the proximal section, at least one intermediate segment coterminous with the at least one intermediate section, and a distal segment coterminous with the distal section.

13. The blender of claim 1, wherein each of the at least one blade includes an inner lumen, the inner lumen being configured and sized to slide over the shaft to removably couple the at least one blade to the shaft.

14. The blender of claim 13, wherein the at least one blade includes multiple blades.

15. The blender of claim 14, wherein at least one of the multiple blades includes a proximal-facing fin, and at least one of the multiple blades includes a distal-facing fin.

16. The blender of claim 14, wherein at least one of the multiple blades includes a radial fin.

17. The blender of claim 14, wherein at least one of the multiple blades includes a spacer having no fins.

18. The blender of claim 14, wherein the multiple blades include blades of different thicknesses.

19. The blender of claim 1, wherein the at least one blade is unitarily formed with the shaft.

20. The blender of claim 1, further comprising at least one semi-circular baffle or at least one axially-extending weir.
